(19) United States
(12) Patent Application Publication
(10) Pub. No.: US 2024/0242251 A1
(43) Pub. Date: Jul. 18, 2024

(54) SYSTEMS AND METHODS FOR ASSET VALUATION

(71) Applicant: CashGenius, Inc., Beaverton, OR (US)

(72) Inventors: Christian Saucier, West Union, SC (US); Allison Vagner, Encinitas, CA (US); Dale Hunt, Escondido, CA (US); Ethelind Mizar, Beaverton, OR (US)

(21) Appl. No.: 18/411,934

(22) Filed: Jan. 12, 2024

Related U.S. Application Data
(60) Provisional application No. 63/479,921, filed on Jan. 13, 2023.

(51) Int. Cl. G06Q 30/02; G06F 21/10; G06F 21/60; G06Q 30/0207; G06Q 30/0226; G06Q 30/08

(52) U.S. Cl. CPC G06Q 30/0278; G06F 21/1014; G06F 21/602; G06Q 30/0209; G06Q 30/0226; G06Q 30/08

(57) ABSTRACT

The invention provided herein generally relates to devices, systems, and methods for valuing assets, including physical and digital, cash and non-cash assets, by transmitting information to an appraiser network including users who submit appraisal bids, wherein the appraiser network users have reputation scores, and wherein the users are incentivized for participation and rewarded based on the asset value and/or sale price. In some embodiments, the asset is digitized, and the invention allows for transactions involving the digitized asset and/or the value of the digitized asset.

### CLAIM OF PRIORITY UNDER 35 U.S.C. § 119

The present Application for Patent claims benefit of Provisional Application No. 63/479,921 entitled “SYSTEMS AND METHODS FOR ASSET VALUATION” filed Jan. 13, 2023, which is hereby expressly incorporated by reference herein.

### BACKGROUND

Estimating the value of an asset is a difficult task. Different people value things differently. Yet, when we exchange things with one another, we find a value agreement we call the “price”. In a voluntary exchange, both the seller and the buyer believe they are better off after the exchange, otherwise they would have walked away from the trade (ref: Mises, “Human Action” 1949). By completing the trade, the parties turn an “estimated price” into a “fair price”. This process, however, is often costly, time consuming, and prone to numerous risks like fraud and other external pressures.

As a result, we created reputable brands, marketplaces and shopping centers, where many buyers can congregate around many sellers in the hopes of reaching a trade at a fair price on quality items. Standardization and commoditization also have an important role to play in asset valuation. Commodity assets are conveniently priced for us in global exchanges where buyers and sellers negotiate the “market price” at which food stocks, metals, energy, and other things society needs find their fair valuation. This facilitates exchanges across the whole of society.

However, what works well for fungible assets works less efficiently for unique assets. It may be very difficult to determine the value of a specific painting found in an attic, an antique chest, a collectible non-fungible token, second-hand concert tickets, or the value of a patent on an invention. These assets do not benefit from having readily available marketplaces to determine their fair value. Instead, one must find a specialist or a local expert to offer a more authoritative estimate. Such experts can be found at auction houses, car dealerships, and pawn shops, a local jewelry store, or the like. In most cases, the expert estimate suffers from multiple weaknesses:
a. The estimate from a single “expert”
b. Experts often disagree with one another
c. Cost of finding an expert can discourage sellers
d. Locality restrains the valuation; global reach increases valuation
e. Assessment independence is rare (the expert is often a party to the trade)

In times of economic hardship, more people will turn to barter and trade, which will increase the demand for fair asset valuation services.

The present invention provides asset owners a way to identify a fair asset price without having to rely on a local expert's opinion. This is accomplished using blockchain technology and gamification techniques described herein.

### SUMMARY

With the maturing of blockchain, peer-to-peer collaboration software, and networking technologies, it is now possible to facilitate collaborative discovery processes like asset valuation. Asset valuation is a complex and chaotic process requiring field expertise and an active marketplace where buyers and sellers are subjected to offer and demand pressures.

The present invention, referred to herein as the Appraisers Network (AN) uses gamified incentives to attract the vast online population in participating in the asset valuation process. The invention attracts assessors and rewards them for sharing their estimate of the valuation of an asset, digital or physical.

Incentivized collaboration finds its theoretical basis in the academic studies of crowd behaviors. The book The Wisdom of Crowds by James Suroyevsky (2004) proposes four necessary conditions for achieving successful crowd coordination in estimating the value of an asset:
a. Diversity of opinion (all opinions are welcome in the AN)
b. Independence of opinion (the AN rewards real opinions and can further reward a “best” or most reliable opinion).
c. Decentralization of perspectives (the more opinions, the better).
d. Date aggregation (the AN calculates fair value from all opinions together).

The AN uses P2P technologies to implement a process that achieves the conditions above toward the specific goal of providing a fair valuation for an asset.

As a result, the invention replaces the need to find a marketplace for asset pricing and provides a faster and cheaper method to determine a fair price for an asset.

Embodiments of the present invention relate to asset-management systems that provide on-location cryptographically secure asset digitization, adapted for handling of one or more items of at least one asset type, the system including: a user interface; an intake portal adapted to: a) receive documented evidence of one or more assets, and b) capture or assign a unique identifier for the asset; a processor adapted to receive, process, and transmit said asset unique identifier; a cryptographically secure immutable digital asset ledger for storing documented evidence of the asset; and a means of providing a cryptographically unique proof of record.

In some embodiments, the asset can include one or more of currency, digital currency, non-fungible tokens (NFTs), legal instruments (e.g., title to any tangible or intangible asset such as real estate, motor vehicles such as cars, motorcycles, boats, or the like), stocks, bonds, intellectual property (e.g., patents, trademarks, copyrights, trade secrets), art, tickets, coupons, tokens (such as casino tokens), notes, banking accounts, digital currency wallets, contracts, promissory notes, private keys, public keys, or any item with value.

In some embodiments, the asset has an accepted value and is thus considered self-validating. In some embodiments, the asset is not self-validating (e.g., wherein the asset includes title), wherein documented evidence of the asset can include more than one form of documentation for verification of a user and/or the asset. In some embodiments, the documented asset evidence can include one or more selected from physical identification, biometric data, witness evidence, multimedia evidence, bank statements, legal documents, chain of title and/or provenance, reputation score, and/or any physical or non-physical documentation relating to the user and/or the asset.

In some embodiments, the user interface and the intake portal can be present on a single device. In some embodiments, the user interface and the intake portal can be present on separate devices. In some embodiments, the user interface can be implemented by an interaction between a machine and a user. In some embodiments, the user interface can include an app for a mobile device, a camera, a screen, a computer program, or a physical key.

In some embodiments, the processor can cryptographically secure the documented evidence captured by the intake portal by generating the unique digital signature of the evidence using a hashing function. In some embodiments, the output of the hashing function can be posted to an immutable digital asset ledger, thereby securing the integrity of the documented evidence received by the input portal.

In some embodiments, the asset unique identifier can be saved locally and on the immutable digital asset ledger. In some embodiments, the immutable digital asset ledger can include a system inventory of multiple asset items present in the system. In some embodiments, the asset unique identifier can include the item's value denomination.

In some embodiments, the asset is not currency. In some embodiments, at least one of the asset types is not currency.

In some embodiments of the invention, the system further includes a physical or digital wallet storing the cryptographically unique proof of record.

In some embodiments, the asset unique identifier can be unique to each asset item within an asset type, such that each asset item of a given asset type is distinguishable from every other item of said asset type.

In some embodiments, the system can provide on-location cryptographic validation of a digital asset, wherein the system recognizes an immutable ledger in which the digital asset is registered and uses the ledger of record to validate the authenticity of the digital asset.

In some embodiments, the digital asset can be subject to a valuation discount factor. In some embodiments, the valuation discount factor can be based on at least one of asset type, strength and/or quality of evidence, reputation of the user, or network appraisal.

In some embodiments, the system can provide on-location cryptographically secure exchange of assets. In some embodiments, exchange of assets involves a user exchanging assets from one type to another. In some embodiments, exchange of assets involves a user exchanging assets to another individual.

Further embodiments of the invention relate to an asset inventory system or asset digital repository system employing any of the features described above.

Further embodiments of the invention relate to an asset exchange system employing any of the features described above.

Further embodiments of the invention relate to an asset-collateralized banking system, including any of the features described above.

Further embodiments of the invention relate to systems as described above and further including a sorter adapted to sort each item of asset input into one of a plurality of primary asset stores, wherein each primary asset store corresponds to an asset type, such that after handling by the sorter each item of asset input is placed in a selected primary asset store according to the asset type of said item of asset input, wherein the primary asset store for a type of physical currency corresponds to the value denomination.

Some embodiments of the AN can employ and interact with systems, devices, and solutions for handling cash or quasi-cash items, and other assets, such as digital assets, in such a way as to substantially eliminate employee theft, error, or difficulties in reconciling a record of transactions with a total amount of money in a cash drawer. One such exemplary system is described in U.S. Pat. No. 11,315,380, entitled DIRECT-SCAN CASH-MANAGEMENT SYSTEMS AND METHODS, issued on Apr. 26, 2022, which is incorporated herein by reference in its entirety, and which is referred to herein as the Cash-Management System, or CMS. In such embodiments of the invention, the AN can be integral to, or can dynamically interact with (such as by app-based communications between the AN and the CMS. Likewise, embodiments of the invention can also interact with the invention disclosed in International Patent Application No PCT/US2022/073745, entitled DIRECT-SCAN CASH- AND DIGITAL ASSET-MANAGEMENT SYSTEMS AND METHODS, filed on Jul. 14, 2022, which is incorporated herein by reference in its entirety, and which is referred to herein as the Cash and Digital Asset-Management System, or CDAMS.

Where the AN interacts with other asset-management systems, such as, for example, the CMS and/or the CDAMS, digital assets can be stored as either fungible or non-fungible assets; for example, fungible assets can be stored in common as a balance of value under an account number, whereas non-fungible assets are held uniquely and cannot be sub-divided in smaller units. Bitcoin is a fungible asset; a collectible sword in a virtual world is a non-fungible asset; both digital assets could be offered as input to some embodiments.

In situations in which the AN is facilitated by physical interaction with a system to receive tangible items, the CMS and/or the CDAMS, and/or other systems having similar capabilities can provide such function.

### BRIEF DESCRIPTION OF THE DRAWINGS

FIG. 1 depicts one embodiment of the AN, with inputs from a buyer and an asserted fair price. This illustrates an exemplary embodiment of the invention wherein a network of appraisers is established and used to value an asset. In this embodiment, information about a physical or digital asset is input into a system for an appraisal request. The appraisal request, including the asset information, is conveyed to a network of appraisers. The appraiser network includes one or more appraisers and can be used to essentially crowdsource to give a best estimate as to the value of an asset or item, wherein users in the appraiser network review the asset information and submit an appraisal estimate. An item value appraisal report can then be generated based on the appraisal valuations submitted by the appraisers. Once the asset is sold or otherwise formally valued from a platform outside of the appraiser network, documentation of the asset price can be conveyed to the network, e.g., in the form of physical or digital documentation, in a feedback loop. One or more users in the appraiser network can then be rewarded on the platform for having a successful or accurate asset valuation or bid; in this way, participation and accuracy on the appraiser network are both incentivized.

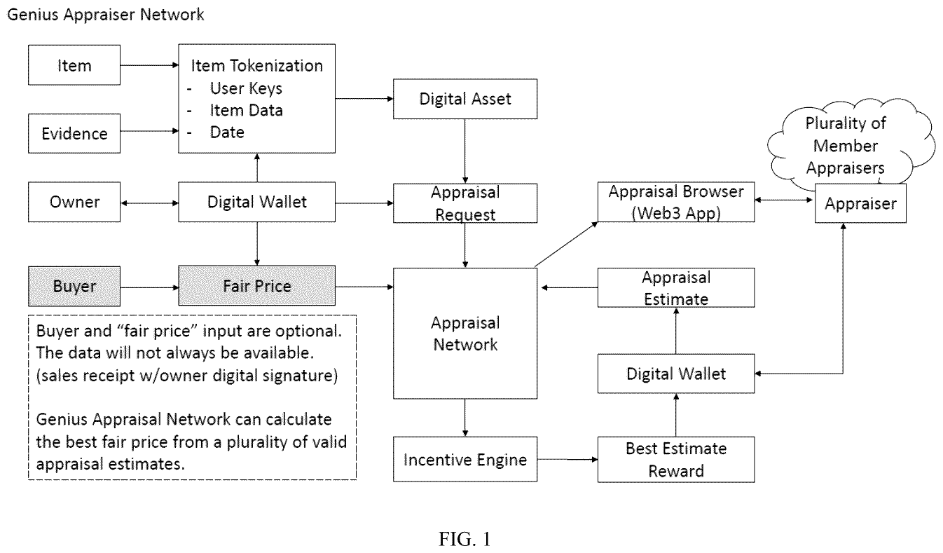

FIG. 2 depicts another embodiment of the AN, with possible inputs from one or more buyers in a marketplace and fair price being determined by inputs from buyers and/or the network of appraisers. When sales price information or evidence is not available, the best fair price is calculated from the plurality of appraisal estimates submitted to the network. The reward engine can include one or more of various reward options, such as monetary rewards (using fiat and/or digital currency), points, tokens, increased user score, etc. A reward can be displayed on the appraiser profile, which indicates the appraiser's experience, reputation score, and appraisal history. A reward can also be deposited into a “wallet” for the appraiser on the platform, where the wallet can include currency (fiat, crypto), tokens, points, and/or other signifiers of value on the system. The platform can retain bidding status and data over time in a secure, immutable ledger for auditing purposes.

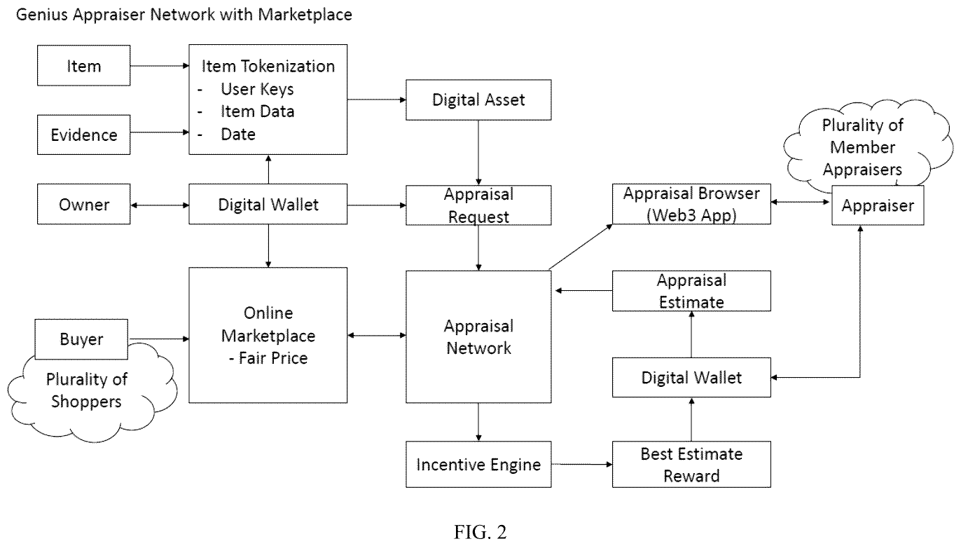

### DETAILED DESCRIPTION

In an exemplary embodiment of the invention wherein the system further comprises a means of digitizing and storing an asset, or some form of documentation of an asset, input into the system. The system provides a transaction receipt to the user, including keys allowing the user to demonstrate ownership of and access the digitized asset held by the system. The transaction can be recorded on a blockchain. The asset can then be digitized into an NFT and placed into a digital asset repository (i.e., a vault of crypto keys). The asset optionally can then be held internally by the system or can be physically transferred out of the system to another location, which can be onsite or offsite at another location. The owner of the digital asset repository or crypto keys vault then reviews the asset and conducts offline curation and selection, which can include valuation, pricing, authentication, and various steps to establish the provenance and/or pricing and/or marketing strategy for the asset. The owner of the digital asset repository or crypto keys vault then can communicate the digitized asset to a third-party marketplace or auction house for resale. Information about a physical or digital asset is input into a system for an appraisal request. The appraisal request, including the asset information, is conveyed to a network of appraisers. The appraiser network includes one or more appraisers and can be used to essentially crowdsource to give a best estimate as to the value of an asset or item, wherein users in the appraiser network review the asset information and submit an appraisal valuation, or bid. An item value appraisal report can then be generated based on the appraisal valuations submitted by the appraisers. Once the asset is sold or otherwise formally valued from a platform outside of the appraiser network, documentation of the asset price can be conveyed to the network, e.g., in the form of physical or digital documentation, in a feedback loop. One or more users in the appraiser network can then be rewarded on the platform for having a successful or accurate asset valuation or bid; in this way, participation and accuracy on the appraiser network are both incentivized. The reward engine can include one or more of various reward options, such as monetary rewards (using fiat and/or digital currency), points, tokens, increased user score, etc. A reward can be displayed on the appraiser profile, which indicates the appraiser's experience, reputation score, and appraisal history. A reward can also be deposited into a “wallet” for the appraiser on the platform, where the wallet can include currency (fiat, crypto), tokens, points, and/or other signifiers of value on the system. The platform can retain bidding status and data over time in a secure, immutable ledger for auditing purposes.

In a further exemplary embodiment of the invention, the system comprises a means of digitizing and storing an asset, or some form of documentation of an asset, input into the system. The system provides a transaction receipt to the user, including keys allowing the user to demonstrate ownership of and access the digitized asset held by the system. The transaction can be recorded on a blockchain. The asset can then be digitized into an NFT and placed into a digital asset repository (i.e., a vault of crypto keys). The asset optionally can then be held internally by the system or can be physically transferred out of the system to another location, which can be onsite or offsite at another location. The owner of the digital asset repository or crypto keys vault then reviews the asset and conducts offline curation and selection, which can include valuation, pricing, authentication, and various steps to establish the provenance and/or pricing and/or marketing strategy for the asset. The owner of the digital asset repository or crypto keys vault then can communicate the digitized asset to a third-party marketplace or auction house for resale. Information about a physical or digital asset is input into a system for an appraisal request. The appraisal request, including the asset information, is conveyed to a network of appraisers. The appraiser network includes one or more appraisers and can be used to essentially crowdsource to give a best estimate as to the value of an asset or item, wherein users in the appraiser network review the asset information and submit an appraisal valuation, or bid. An item value appraisal report can then be generated based on the appraisal valuations submitted by the appraisers. Once the asset is sold or otherwise formally valued from a platform outside of the appraiser network, documentation of the asset price can be conveyed to the network, e.g., in the form of physical or digital documentation, in a feedback loop. One or more users in the appraiser network can then be rewarded on the platform for having a successful or accurate asset valuation or bid; in this way, participation and accuracy on the appraiser network are both incentivized. The reward engine can include one or more of various reward options, such as monetary rewards (using fiat and/or digital currency), points, tokens, increased user score, etc. A reward can be displayed on the appraiser profile, which indicates the appraiser's experience, reputation score, and appraisal history. A reward can also be deposited into a “wallet” for the appraiser on the platform, where the wallet can include currency (fiat, crypto), tokens, points, and/or other signifiers of value on the system. The platform can retain bidding status and data over time in a secure, immutable ledger for auditing purposes. The system further comprises a marketplace where buyers can review, purchase, or bid on the digitized asset via the third-party auction house or marketplace. The purchaser or winning bidder then makes payment for and receives the asset, after which time the payment is verified and conveys to the user who originally input the asset. Upon receipt and acceptance of payment, user has the payment, and the ownership of the asset is now with the buyer, and evidence of the new ownership can be recorded on the blockchain.

An auction house in general is a public place where buyers are invited to come and look, or browse as on eBay, which has a database of assets. A separate digital assets repository can be created at a physical or online auction house or marketplace location. The NFT stamp which represents the unique digital asset is the digital twin of the physical asset, such as the paper car title. When a digital stamp is stored in a local database, it is usually called a crypto wallet. It is a wallet because it contains the keys that control the asset, and it is the owner that proves the ownership of the asset. When, for example, a car title is inserted into the system, it is now stored in the system's digital wallet.

The digitized asset stored in the system can be called back, but is stored in the system until that time, such that a transaction involving a digital asset and a marketplace or auction house may never involve the asset physically going to the marketplace or auction house. It is expected that a third party, such as, for example, a third-party bank, may host the system or network of systems, and therefore would host the system storing the digitized asset.

The third party hosting the system or network of systems may monitor the digital assets repository whenever something new comes into the system, in order to verify the asset before showing it to anyone or before even valuing it. This could be fully remote, such as, for example, someone in China, managing a casino in Las Vegas. In this scenario, when a new digitized asset such as, for example, a car title, is received into the system, the individual in China can review the asset, zoom in on the data, call the DMV to verify, and various other authentication steps which could lead to an approval process.

The asset entered into the system can also be, for example, a smart contract. In the case of smart contracts, whenever a digital asset is moved into the digital asset repository, it effectively creates a smart contract. The smart contract created in this fashion can have ifs and thens and can be tended to as an asset, which itself has value; for practical purposes, it may be useful to set a minimum value for a contract entered into the system, such as, for example, $10,000. Such a smart contract can be reviewed by a high-level individual within the organization managing the system or network of systems, and the smart contract can be sent to that individual for review. An individual can go to the system and look at the contract to verify its value. Using cryptocurrency and blockchain technology allows the process to be programmed to address the conditions for the flow of unique value.

Embodiments of the invention also encompass the establishment and use of a network of appraisers (also referred to herein as an appraiser network or AN) to value an asset, once information about a physical or digital is input into a system. Asset information can include, for example, evidence of ownership of the asset, photographs, titles, documentation of the asset and its condition, other appraisals, purchase receipts or documentation, documentation of sale price and/or valuation of similar items, and the like. The AN includes one or more users and can be used to essentially crowdsource to give a best estimate as to the value of an asset or item, wherein users in the AN review the asset information and submit an appraisal valuation, or bid. The appraisal valuations or bids received from the users on the AN are aggregated and documented, for example on an immutable ledger which receives appraisal bids and secures system operations. The platform can determine the average valuation range and/or can value the asset as a consensus value range. The asset can also include a group of assets, or an asset portfolio.

Once the asset is sold or otherwise formally valued from a platform outside of the AN, documentation of the asset price can be conveyed to the network, e.g., in the form of physical or digital documentation, in a feedback loop. One or more users in the AN can then be rewarded on the platform for having a successful or accurate asset valuation or bid; in this way, participation and accuracy on the AN are both incentivized. The reward engine can include one or more of various reward options, such as monetary rewards (using fiat and/or digital currency), points, tokens, increased user score, etc. The platform can retain bidding status and data over time in a secure, immutable ledger for auditing purposes.

Each user on the AN is subject to reputation scoring, which aggregates information over time and assigns a score to each user. Information which can affect a user's score includes the user's reputational information (such as, for example, the user's activity on the platform, completion of the user profile, the user's historical success rate, the user's bid/valuation accuracy over time, information from the user's curriculum vitae, such as educational and employment history, etc.), feedback from other users, the user's appraisal valuation/bid success rate, etc. The scores can be weighted, for example, by a scoring interface. Different user types may have the ability to weight, add or subtract from, and/or otherwise influence the score of a fellow user, and different user types may have different scoring capabilities and/or different scoring interfaces. A user inputting an asset and requesting a valuation can be scored as well. For example, a user can receive a negative score for poor quality requests/products.

In this way, the AN additionally can be gamified such that users on the network are ranked according to their experience and success rate, and are rewarded for accurate valuations (also referred to herein as bids). The AN acts as a social network, which empowers users to use and benefit from their own expertise.

This valuation estimate can be used as a standalone valuation tool anywhere an asset value estimation is useful. The valuation is also particularly useful in the systems as described in the preceding paragraphs, wherein the system can receive an asset, or a digitized representation thereof (such as a type of document, e.g., a deed to house or vehicle, a piece of art, etc.), at a location which is not able to determine a value for the asset, or which is not able to determine a value for the asset at that moment in time. For example, a digitized asset, such as a deed or a piece of art, can be input into the system at a location such as a casino, which has no way of reliably ascribing a value to the asset in a timely fashion (or at all).

The AN can provide a gamified way for the owner of an asset (e.g., a physical or digitized asset, digital wallet, etc.) to get exposure to a group of appraisers in order to determine an accurate value for an asset. In this gamified system, appraisers, or users, play a game of betting on the value for an asset. The system can incentivize non-cheating by rewarding users who have values, or bids, which are the closest to the actual value or sale price of the asset, once the owner of the asset inputs the real world value or sale price into the system following a sale or other formal or certified valuation.

Successful users can receive a reward on the platform. For example, one type of reward is an increase in the user's ranking and/or reputational score, thereby making the opinion or future valuations or bids from that user more highly weighted. This method of distributing rewards acts to incentivize users to give good, or accurate, values.

For example, a user may have an asset and may be located at a venue wanting to receive a value or physical currency for the asset (such as, a user at a casino and wanting cash or casino chips in exchange for a motorcycle title). The user can input the title into the system described herein, which digitizes the asset and provides a receipt. The receipt can have a QR code which can be scanned by an app, or by the casino, etc., as well as the digital key(s) which still control ownership (i.e., mathematic proof of ownership), which can be used by the user to force a claim. The system after digitizing the asset has the digital keys to the asset, while the user has the code. The digitized asset can be presented to the AN for a valuation request, which can then provide a value for the item (e.g., how much is item worth in that location, at that moment in time). Members of the AN will see the new valuation request when they interact with the system and can review all information associated with the valuation request. The system is necessarily flexible/adaptable to determine what kind of validating info is necessary before moving forward with the valuation request. Appraisers on the network can submit transactions with their valuations, at some point someone can call a price, or there will be a purchase.

The AN is a form of “smart contract”, with a set of rules. The gamification of the AN acts as a set of tools, to improve accuracy and outcomes. The gamification aspect can provide rewards, such as stars, ratings, rankings, weighting, platform tokens, etc., which in turn improve the quality of the valuations provided by the AN. Submitted appraisals are entered as a smart contract and are tracked on the system or platform. In this system, all valuations and final values or sale prices are recorded on an immutable ledger, such as on a blockchain, for transparency and for auditing purposes.

The user who entered the asset into the system can receive reports from the appraisals. When an actual transaction is completed or a formal valuation is received, the user who entered the asset into the system can submit the actual sale price or formal valuation to identify the best appraisal. The member(s) of the AN with the most accurate valuation can then be rewarded on the platform for having the best valuation. For example, the system can reward the user with, for example, stars, ratings, rankings, weighting, platform tokens (such as, for example, an extra crypto appraisal network token).

In the example having a network which receives and digitizes an asset, and which also includes the AN, the system can further be used as a marketplace, where the asset can receive a valuation and further can be listed for sale on the platform, and potentially purchased, based on the valuation. In this manner, the system can become a marketplace for any digitized asset which can receive a valuation from the AN.

The appraisal network can have its own crypto appraisal network token, which can initially be free but which will have a value published to the network. The system of crypto economics can be used to define the gamified rewards system. The system can use multiple tokens, such as a pricing token, e.g., using an existing crypto currency, and/or the system can operate using its own appraisal network token. Any such token can optionally be priced to the dollar for stability. A currency token can be used on the network such that payments are made using the currency token when a user consumes from the network. For example, a user requesting an appraisal may need to pay a nominal fee in a fiat currency, crypto currency, or currency token created for the network, such as by paying a fee in said currency to input or digitize an item. The charge can convert to cryptocurrency in the AN. The tokens created on the network will be limited in number and therefore will have a value in accordance with the limited amount of currency issued. The currency will be available to users via offers or by rewards received for various actions on the system. The currency value on the network can change over time depending on economics and market factors, such that the system can become a crypto marketplace of NFTs. Users can receive loyalty rewards, e.g., for keeping cash/currency, or assets, in the system for a certain amount of time.

The system can optionally charge a fee for submission of an asset to be valued, and/or the system can additionally optionally be paid a fee or percentage of the item sale price for a successful valuation or bid. When the system becomes a marketplace for transactions involving a digitized asset which receives a valuation from the AN, the system can additionally optionally be paid a fee or percentage of the item sale price, and/or the user with the most accurate valuation or bid can additionally optionally be paid a fee or percentage of the item sale price, in addition to receiving other rewards on the platform for the valuation success and accuracy.

Because individuals (appraisers) are involved, the system lends itself to a traditional governance model or to a decentralized autonomous organization (DAO) system of governance. A DAO is essentially a governance loop which brings individuals into aspects of governance, with feedback from the network, such as the AN, and arbitration models.

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that can have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A method for valuing an asset, the method comprising:
receiving documented evidence regarding a physical or digital asset;
transmitting the documented asset evidence to an AN, wherein the AN comprises:
one or more users capable of reviewing the asset evidence and submitting an appraisal bid;
logic to facilitate aggregation of appraisal bids;
an immutable ledger on which appraisal bids are received and which secures system operations;
reputation scoring capabilities which aggregate information over time, comprising:
assigning a reputation score to each AN user, wherein the score can be up or down modified by:
a user's reputational information;
feedback from other users; and
appraisal bid success rate; and
receiving and aggregating appraisal bids from the AN, comprising:
capturing appraisal bids from one or more users via one or more interface;
aggregating the appraisal bids;
weighting scores according to the reputation score of each user submitting an appraisal bid; and
analyzing the aggregation of appraisal bids for asset valuation;
receiving physical or digital documentation regarding asset value and/or sale price;
rewarding one or more users on the AN by a reward engine, comprising:
an incentive structure for participation and/or accurate appraisal bids;
customization of a plurality of reward options; and
weighting user scores based on comparison analysis of bids with asset value and/or sale price; and
retaining bidding status and data over time in a secure, immutable ledger for auding purposes.

2. The method of claim 1, wherein the asset comprises one or more selected from currency, digital currency, non-fungible tokens (NFTs), legal instruments, stocks, bonds, intellectual property, art, tickets, coupons, tokens, notes, banking accounts, digital currency wallets, contracts, promissory notes, private keys, public keys, or any item with documentable value, or a group or portfolio of such assets.

3. The method of claim 1, wherein the asset is self-validating.

4. The method of claim 1, wherein the asset is not self-validating and wherein documented evidence of the asset comprises more than one form of documentation for verification of a user and/or the asset.

5. The method of claim 1, wherein the documented asset evidence comprises one or more selected from physical identification, biometric data, witness evidence, multimedia evidence, bank statements, legal documents, chain of title and/or provenance, reputation score, and/or any physical documentation relating to the user and/or the asset.

6. The method of claim 1, wherein assigning a reputation score to each AN user comprises internal and/or external inputs, public and/or private inputs, and/or input from gamification within the network.

7. The method of claim 1, wherein the user's reputational information comprises one or more of the user activity, profile completion, historical bid success rate, accuracy over time, and/or documented educational and/or professional experience.

8. The method of claim 1, wherein users have access to an interface for scoring other users, optionally wherein different scoring interfaces are available for different user types.

9. The method of claim 1, wherein the reward options comprise one or more of currency, points, tokens, and/or increased reputation score.

10. The method of claim 1, wherein rewarding one or more users on the AN after receiving physical or digital documentation regarding asset value and/or sale price comprises a feedback loop which increases accuracy of future bids from the AN.

11. The method of claim 1, further comprising an asset-management system that provides on-location cryptographically secure asset digitization, adapted for handling of one or more items of at least one asset type, the system comprising:
a user interface;
an intake portal adapted to: a) receive documented evidence of one or more assets, and b) capture or assign a unique identifier for the asset;
a processor adapted to receive, process, and transmit said asset unique identifier;
a cryptographically secure immutable digital asset ledger for storing documented evidence of the asset;
and a means of providing a cryptographically unique proof of record.

12. The method of claim 1, wherein the user interface and the intake portal are present on a single device.

13. The method of claim 1, wherein the user interface and the intake portal are present on separate devices.

14. The method of claim 1, wherein the user interface is implemented by an interaction between a machine and a user.

15. The method of claim 1, wherein the user interface comprises an app for a mobile device, a camera, a screen, a computer program, or a physical key.

16. The method of claim 1, wherein the intake portal comprises one or more types of document imaging technology to provide the system with documented evidence of an asset.

17. The method of claim 1, wherein the intake portal comprises a scanner.

18. The method of claim 1, wherein the intake portal captures the unique identifier present on the asset if the asset is self-validating, or creates a new unique identifier if the asset is not self-validating.

19. The method of claim 1, wherein the processor cryptographically secures the documented evidence captured by the intake portal by generating the unique digital signature of the evidence using a hashing function.

20. The method of claim 1, wherein the output of the hashing function is posted to an immutable digital asset ledger, thereby securing the integrity of the documented evidence received by the input portal.

21-37. (canceled)
